(19) United States
(12) Patent Application Publication
(10) Pub. No.: US 2013/0183175 A1
(43) Pub. Date: Jul. 18, 2013

(54) DRIVING DEVICE

(71) Applicant: ASMO CO., LTD., Shizuoka-ken (JP)

(72) Inventors: Masaru IRIE, Shizuoka-shi (JP); Toshihiro MATSUURA, Hamamatsu-shi (JP); Hiroki OZAKI, Gamagori-shi (JP)

(73) Assignee: ASMO CO., LTD., Shizuoka-ken (JP)

(21) Appl. No.: 13/742,900

(22) Filed: Jan. 16, 2013

(30) Foreign Application Priority Data
Jan. 17, 2012 (JP) 2012-007364
Dec. 5, 2012 (JP) 2012-266527

(51) Int. Cl. H02K 1/27; F04C 11/00

(52) U.S. Cl. CPC H02K 1/2746; F04C 11/008
USPC 417/410.4; 310/156.53

(57) ABSTRACT

A driving device includes a rotor unit including a rotation shaft, a fluid supplying portion, and a motor rotor, a housing that rotatably supports the rotation shaft, a stator case accommodating a motor stator and a motor rotor. The motor rotor includes a consequent pole rotor including a motor rotor core and a plurality of the magnets arranged along a circumferential direction of the motor rotor core. The magnets form a plurality of magnetic pole portions that serve as primary magnetic poles. The motor rotor core includes portions located between adjacent ones of the magnetic pole portions in the circumferential direction. The portions form magnetic-pole-forming portions that serve as secondary magnetic poles. The motor unit includes a magnetization inhibiting portion formed to inhibit magnetization of the fluid supplying portion. The support portion of the housing comprises a nonmagnetic metal.

### BACKGROUND OF THE INVENTION

The present invention relates to a driving device such as an electric pump that draws in and discharges a fluid such as oil.

Japanese Patent No. 4042050 discloses an electric pump that includes a pump housing, a stator case, which is fixed to the pump housing, and a rotation shaft. The rotation shaft includes a first end, a second end, and an axially middle portion. The pump housing includes a support bore that rotatably supports the axially middle portion of the rotation shaft. The stator case accommodates a motor stator. The motor stator accommodates a motor rotor, which is arranged on the first end of the rotation shaft. The pump housing has one end including a cavity that forms part of a pump chamber. The second end of the rotation shaft, which extends out of the bore, is received by the cavity. A pump portion, which is arranged in the cavity, is coupled to the second end of the rotation shaft.

Generally, in a motor rotor for a driving device such as the electric pump described above, magnets of different polarities (north and south poles) are alternately arranged in the circumferential direction. Such a motor rotor requires many magnets and is thus expensive. Accordingly, there is a need for a driving device that operates in a satisfactory manner with an inexpensive motor rotor.

### SUMMARY OF THE INVENTION

It is an object of the present invention to provide a driving device that operates in a satisfactory manner with an inexpensive motor rotor.

One aspect of the present invention is a driving device including a rotor unit, which includes a rotation shaft, a fluid supplying portion, and a motor rotor, wherein the rotation shaft includes a first end portion, a second end portion, and a middle portion, the fluid supplying portion is arranged at the first end portion of the rotation shaft, and the motor rotor is arranged at the second end portion of the rotation shaft, a housing including a first end portion, a second end portion, and a support portion, which rotatably supports the middle portion of the rotation shaft, wherein the first end portion includes a supplying chamber that accommodates the fluid supplying portion, and a stator case arranged adjacent to the second end portion of the housing, wherein the stator case accommodates a motor stator and a motor rotor arranged in the motor stator, and the motor stator fixed to the stator housing. The motor rotor forms a consequent pole rotor including a motor rotor core and a plurality of magnets arranged along a circumferential direction of the motor rotor core. The magnets form a plurality of magnetic pole portions each serving as a primary magnetic pole. The motor rotor core includes a portion located between adjacent ones of the magnetic pole portions in the circumferential direction that defines a magnetic-pole-forming portion serving as a secondary magnetic pole. The motor unit includes a magnetization inhibiting portion formed to inhibit magnetization of the fluid supplying portion. The support portion of the housing includes a nonmagnetic metal.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view showing an electric pump according to one embodiment of the present invention;

FIG. 2 is an exploded cross-sectional view showing the electric pump of FIG. 1;

FIGS. 3 and 4 are perspective views showing the electric pump of FIG. 1;

FIG. 5 is a schematic view showing a pump rotor in the electric pump of FIG. 1;

FIG. 6 is a cross-sectional view showing an electric pump according to another embodiment of the present invention;

FIGS. 7A to 7C are partial cross-sectional views showing electric pumps according to further embodiments of the present inventions; and

FIG. 8 is a plan view showing a motor rotor and a rotation shaft according to yet another embodiment of the present invention.

### DETAILED DESCRIPTION OF THE INVENTION

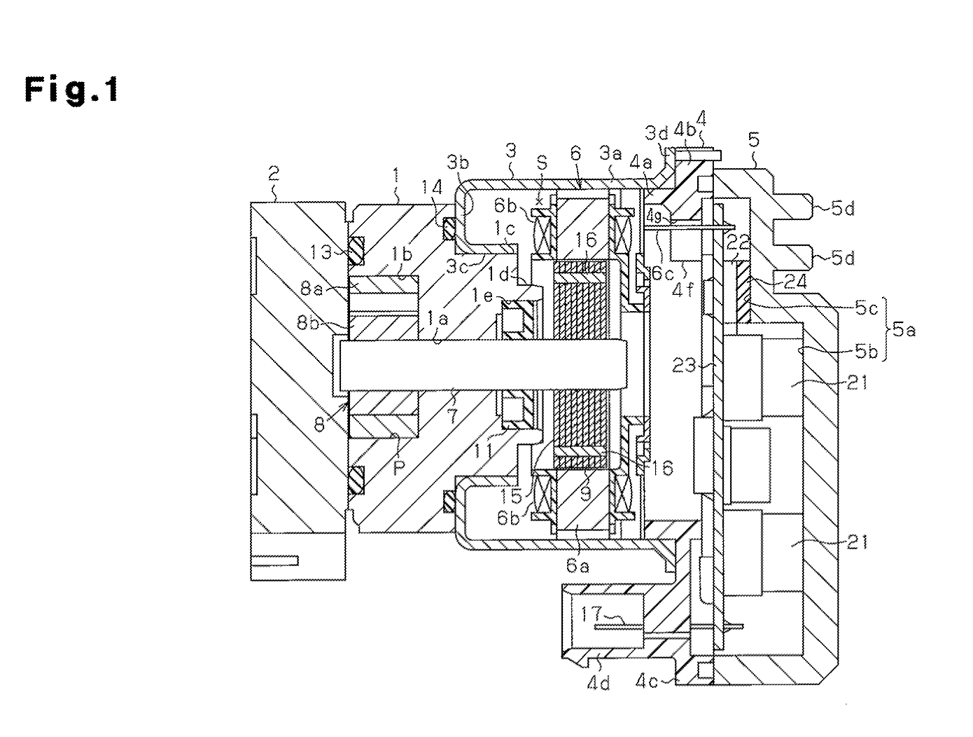

An electric pump according to one embodiment of the present invention will now be described with reference to FIGS. 1 to 5. The electric pump is used to circulate oil in a vehicle.

As shown in FIG. 1, the electric pump includes a pump housing 1, a pump end plate 2, a stator case 3, a circuit case 4, and a heat sink cover 5, which as a whole form a frame. The electric pump includes in the frame a motor stator 6, a rotation shaft 7, a pump rotor 8, a motor rotor 9, and circuit components. The pump rotor 8 functions as a fluid supplying portion. In FIG. 1, the left side is referred to as a first side, and the right side is referred to as a second side.

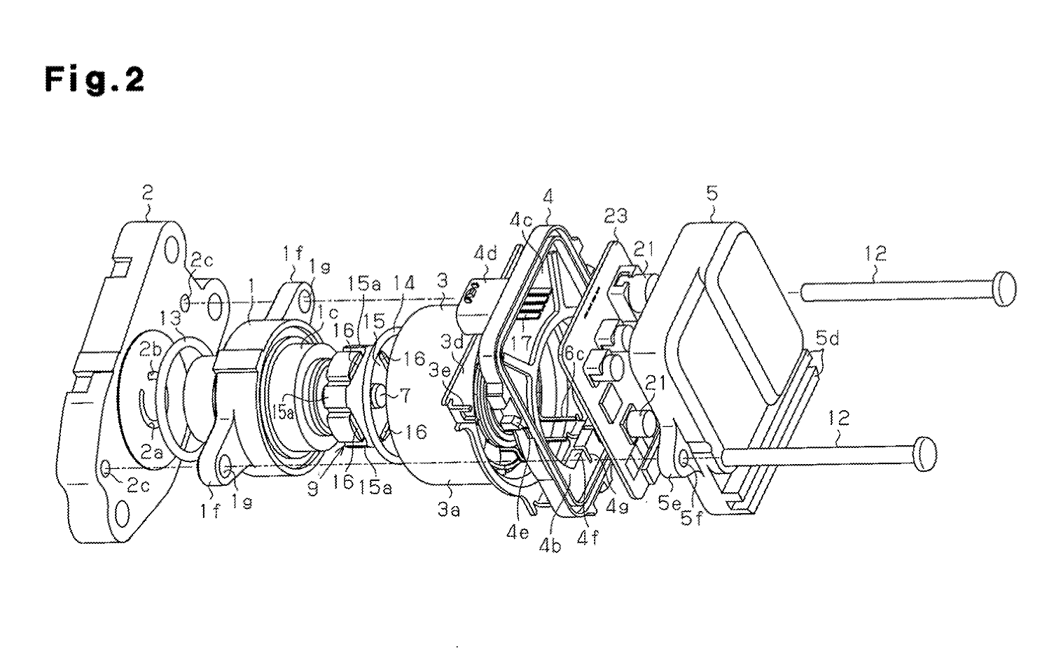

The pump housing 1 is made of metal, specifically, an aluminum alloy that is a nonmagnetic metal. The pump housing 1 is cylindrical and includes a support bore 1a that extends along the axis of the pump housing 1 and rotatably supports an axial middle portion of the rotation shaft 7. The rotation shaft 7 of the present embodiment is made of stainless steel, which is a nonmagnetic metal. The pump housing 1 includes a first end portion (left end as viewed in FIG. 1) having a cavity 1b that forms part of a pump chamber P, which functions as a supplying chamber. The cavity 1b is circular and has an axis that is offset from the axis of the support bore 1a in the pump housing 1. The pump housing 1 also includes a second end portion (right end as viewed in FIG. 1) from which a fitting tube 1c projects. The fitting tube 1c has a smaller outer diameter than the pump housing 1. A small tube 1d, which has a smaller outer diameter than the fitting tube 1c, projects from the fitting tube 1c. The second end portion of the pump housing 1, including the small tube 1d, defines an oil-seal receptacle 1e. The oil-seal receptacle 1e has a larger inner diameter than the support bore 1a and is formed to accommodate and hold an oil seal 11. The oil seal 11 is fitted in and held by the oil-seal receptacle 1e and on the rotation shaft 7. The oil seal 11 serves as a fluid seal between the pump chamber P (left side as viewed in FIG. 1) and an accommodating chamber S, which accommodates the motor stator 6 (right side as viewed in FIG. 1). As shown in FIG. 2, two fixing projections 1f extend radially outward from the circumference of the pump housing 1 at the first end portion. A fixing bore 1g extends in the axial direction through each fixing projection 1f. The pump end plate 2 is fixed to the first end portion of the pump housing 1.

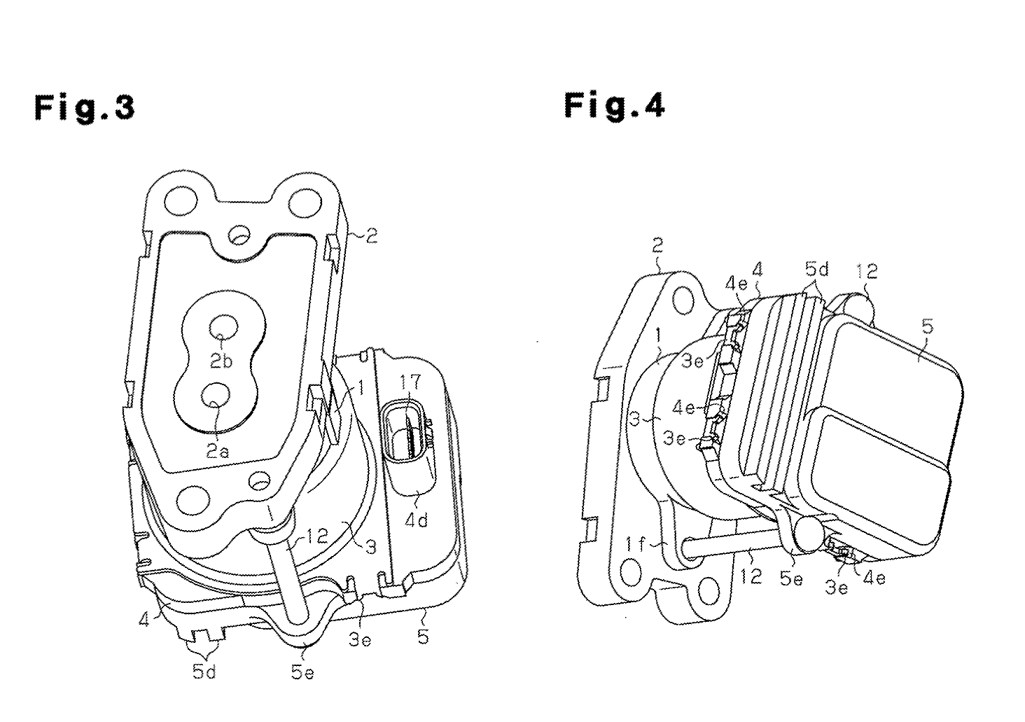

The pump end plate 2 is made of metal, specifically, an aluminum alloy that is a nonmagnetic metal. As shown in FIG. 1, the pump end plate 2 substantially closes the cavity 1b and forms the pump chamber P with the cavity 1b. As shown in FIGS. 2 and 3, the pump end plate 2 includes a suction port 2a and a discharge port 2b that communicate the exterior of the electric pump and the pump chamber P. As shown in FIG. 2, the pump end plate 2 includes threaded bores 2c at positions corresponding to the fixing bores 1g. The pump end plate 2 is fixed to the pump housing 1 by bolts 12. A seal ring 13 is sandwiched between the pump housing 1 and the pump end plate 2 to ensure sealing of the pump chamber P. The pump rotor 8 is arranged around a first end portion of the rotation shaft 7 in the pump chamber P.

The pump rotor 8 of the present embodiment is of an internal gear type that includes an outer rotor 8a having an n number of teeth (n is an integer of three or more) and an inner rotor 8b having an n−1 number of teeth. The first end portion of the rotation shaft 7 is press-fitted into and fixed to the inner rotor 8b.

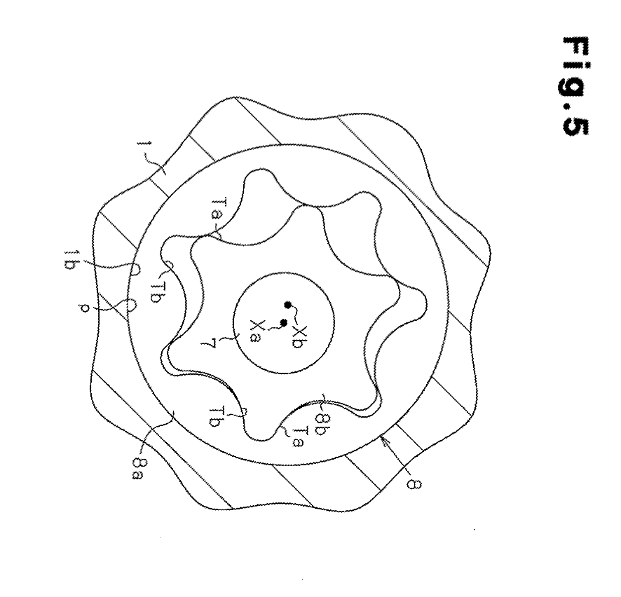

Specifically, the inner rotor 8b of the present embodiment has six external teeth Ta as shown in FIG. 5. The outer rotor 8a has seven grooves (teeth) Tb that engage with the external teeth Ta. Rotation of the inner rotor 8b rotates and moves the outer rotor 8a along the wall of the cavity 1b in the pump chamber P. The outer rotor 8a rotates about an axis Xb that is offset from the axis Xa of the inner rotor 8b and the rotation shaft 7.

The stator case 3 is fixed to the second end portion of the housing 1. The stator case 3 is made of metal and accommodates the motor stator 6, which is fixed to the stator case 3, as shown in FIG. 1. The stator case 3 also accommodates the motor rotor 9, which is arranged on a second end of the rotation shaft 7, at the inner side of the motor stator 6. More specifically, the stator case 3 is formed from a metal plate and includes a large tube 3a, a disk 3b extending radially inward from a first end of the large tube 3a, and a fitting tube 3c extending in the axial direction from the inner edge of the disk 3b toward a second end of the large tube 3a. The large tube 3a accommodates the motor stator 6 that is press-fitted and fixed to the inner circumference of the large tube 3a. The fitting tube 1c of the housing 1 is fitted into the fitting tube 3c to form a fitting joint, specifically, a spigot-and-socket joint. Preferably, the stator case 3 is formed integrally by undergoing pressing.

The stator case 3 is fixed to the pump housing 1 by the bolts 12, with the fitting tube 1c of the pump housing 1 fitted in the fitting tube 3c of the stator case 3. A seal ring 14 is sandwiched between the pump housing 1 and the disk 3b of the stator case 3 to ensure sealing.

The motor stator 6 and the motor rotor 9 form an inner rotor brushless motor. The motor stator 6 includes a stator core 6a and a plurality of windings 6b that are wound around a plurality of teeth of the stator core 6a. The diameter of the above-described fitting joint, which is the outer diameter of the fitting tube 1c of the pump housing 1 and the inner diameter of the fitting tube 3c of the stator case 3, is larger than the inner diameter of the motor stator 6. As shown in FIGS. 1 and 2, the motor rotor 9 is fitted on the rotation shaft 7. A motor rotor core 15 includes a plurality of (e.g., four) magnets that are arranged, more specifically, embedded, along the circumferential direction at equal angular intervals. The magnets 16 form a plurality of (e.g., four) magnetic pole portions each serving as a primary magnetic pole. The portions of the motor rotor core 15 located between adjacent ones of the magnetic pole portions in the circumferential direction define magnetic-pole-forming portions 15a each serving as a secondary magnetic pole (see FIG. 2). In other words, the motor rotor 9 is a consequent pole rotor. The motor rotor 9 of the present embodiment is also an interior permanent magnet rotor in which the magnets 16 are embedded in the motor rotor core 15. In addition, the motor rotor 9 of the present embodiment includes a plurality of laminated core sheets. Furthermore, the motor rotor 9 of the present invention is a flat rotor having a diameter that is greater than its axial length. The axial length of the motor rotor 9 of the present invention is greater than the axial length of the pump rotor 8.

The rotation shaft 7, the pump rotor 8, and the motor rotor 9 form a rotor unit. In the rotor unit, the rotation shaft 7, which is made of a nonmagnetic metal, serves as a magnetization inhibiting portion that inhibits magnetization of the pump rotor 8. The rotation shaft 7 also serves as a magnetic resistance portion arranged between the magnets 16 and the pump rotor 8.

The rotor unit is formed such that the weight moment at the portion from the axial center of the support bore 1a to the pump rotor 8 conforms to the weight moment at the portion from the axial center of the support bore 1a to the motor rotor 9. The weight moment is determined by factors including the weights of the pump rotor 8 and the motor rotor 9 and the distances from the axial center of the support bore 1a to the pump rotor 8 and to the motor rotor 9.

The axial center of the motor stator 6 is slightly offset in the axial direction from the axial center of the motor rotor 9. In the present embodiment, the motor stator 6 is arranged such that its axial center is offset from the axial center of the motor rotor 9 toward the second side (toward the right as viewed in FIG. 1). Accordingly, the motor rotor 9 and the pump rotor 8 are constantly urged toward the second side. The urging force causes the pump rotor 8 to abut against and slide on the bottom of the cavity 1b. The pump rotor 8 is urged in a direction opposite the discharge port 2b as viewed from the chamber P. This direction is the same as the direction in which the pump rotor 8 is urged by the oil in the discharge port 2b, thereby enhancing the effect of urging the pump rotor 8 toward the second side.

The circuit case 4 is fixed to the second end of the large tube 3a of the stator case 3. The stator case 3 includes a flange 3d extending radially outward from the open second end of the large tube 3a. As shown in FIG. 2, a plurality of tabs 3e (only one shown) extend in the axial direction from the flange 3d. Each of the tabs 3e has a distal end including two arms. Referring to FIG. 1, the circuit case 4 is made of resin and includes a tube 4a, which is fitted into the second end of the stator case 3, and a contact plate portion 4b, which extends radially outward from a second end (right end as viewed in FIG. 1) of the tube 4a along the flange 3d. The contact plate portion 4b contacts and covers the end face of the flange 3d. The circuit case 4 further includes an extension 4c, which extends radially outward (downward as viewed in FIG. 1) from the contact plate portion 4b, and a tubular connector 4d, which extends from the extension 4c in the axial direction toward the first side (left side as viewed in FIG. 1). The connector 4d accommodates a first end of a connecting terminal 17 embedded in the extension 4c. As shown in FIGS. 2 and 4, slots 4e are arranged on the periphery of the contact plate portion 4b at positions corresponding to the tabs 3e to receive the tabs 3e. Each tab 3e is fitted to the corresponding slot 4e. Then, the two arms of the tab 3e are bent away from each other to fix the tab 3e to the slot 4e. In the present embodiment, the tab 3e and the slot 4e form a holding structure that prevents relative movement between the stator case 3 and the circuit case 4. The holding structure temporarily fixes the stator case 3 and the circuit case 4 to each other. The bolts 12 are used to rigidly fix the stator case 3 and the circuit case 4.

As shown in FIGS. 1 and 2, the circuit case 4 also includes an inward extension 4f that extends radially inward from the second end (right end as viewed in FIG. 1) of the tube 4a. The inward extension 4f includes a plurality of holding portions, or holding grooves 4g, that hold and guide coil connecting terminals 6c extending from the windings 6b toward the second side.

A circuit board on which various circuit components such as a capacitor 21 and a power transistor 22 are mounted is fixed to a second side (the right side in FIG. 1) of the circuit case 4. The circuit board 23 includes a plurality of connecting holes into which the coil connecting terminals 6c, which extend out of the holding grooves 4g, and the second ends of the connecting terminals 17 are insertable. The coil connecting terminals 6c and the connecting terminals 17, which are inserted in the connecting holes, are connected and soldered to the circuit board 23 after the circuit case 4 is fixed to the stator case 3 by the holding structure described above.

As shown in FIGS. 1 and 2, the heat sink cover 5 is fixed to the circuit case 4 such that the circuit case 4 is sandwiched between the heat sink cover 5 and the stator case 3. The heat sink cover 5 is made of metal and includes, as shown in FIG. 1, an accommodating portion 5a that accommodates the circuit components such as the capacitor 21 and the power transistor 22. The accommodating portion 5a opens to the stator case 3. The accommodating portion 5a includes a large cavity 5b, which is deep in the axial direction to accommodate relatively large circuit components such as the capacitor 21, and a small cavity 5c, which is shallow in the axial direction to accommodate relatively small or thin circuit components such as the power transistor 22. The power transistor 22 allows switching control of the electric current supplied to the windings 6b. As shown in FIG. 1, a silicone rubber member 24, which is an elastic member, is sandwiched between the transistor 22 and the bottom surface of the small cavity 5c.

As shown in FIGS. 1 and 2, the heat sink cover 5 includes fins 5d that project in the axial direction from the outer end face at positions corresponding to the small cavity 5c. The fins 5 do not project beyond the portion of the outer end face that corresponds to the large cavity 5b as shown in FIG. 1. As shown in FIG. 2, the heat sink cover 5 includes two fixing projections 5e (only one shown) project radially outward from the periphery of the heat sink cover 5 at positions corresponding to the fixing bores 1g and the threaded bores 2c. The fixing projections 5e each include a fixing bore extending in the axial direction. The heat sink cover 5 is fixed to the circuit case 4 by the bolts 12 such that the circuit case 4 is sandwiched between the stator case 3 and the heat sink cover 5. The bolts 12 are inserted through the fixing bores 5f and the fixing bore 1g and fastened to the threaded bores 2c.

The operation of the present embodiment will now be described.

When electric current (three-phase driving current) is supplied to the windings 6b through the connecting terminal 17 and the circuit components on the circuit board 23 from an external source (not shown), a rotating magnetic field is generated in the motor stator 6. The rotating magnetic field rotates the rotor unit, which includes the motor rotor 9, rotation shaft 7, and pump rotor 8. The rotating pump rotor 8 draws oil through the suction port 2a and discharges the oil through the discharge port 2b.

The advantages of the present embodiment will now be described.

(1) The motor rotor 9 is a consequent pole rotor that includes a plurality of magnets arranged along the circumferential direction of the motor rotor core 15. The magnets form magnetic pole portions that serve as primary magnetic poles. Portions located between adjacent ones of the magnetic pole portions of the motor rotor core 15 are magnetic-pole-forming portions 15a that serve as secondary magnetic poles (see FIG. 2). Such a structure requires fewer magnets and thus reduces the cost.

In the consequent pole rotor, each magnetic-pole-forming portion 15a serving as the second magnetic pole is a pseudo-magnetic pole and is not a real magnetic pole. In the vicinity of each magnet 16, the absence of a magnet having a different pole results in the magnetic flux of the magnet 16 easily spreading to portions other than the magnetic-pole-forming portions 15a. For this reason, the rotor unit of the present embodiment includes the rotation shaft 7, which is made of a nonmagnetic metal and serves as the magnetization inhibiting portion, to inhibit magnetization of the pump rotor 8. Accordingly, the magnetization inhibiting portion inhibits iron particle and the like from being attracted and adhered to the pump rotor 8 by magnetic force thereby allowing for the pump rotor 8 to operate in a satisfactory manner. To be more specific, in the present embodiment, the spreading of the magnetic flux from the magnets 16 to the rotation shaft 7 is prevented or minimized because the rotation shaft 7, which is made of a nonmagnetic metal and arranged between the magnets 16 and the pump rotor 8, serves as a magnetic resistance portion. The rotation shaft 7 thus inhibits the pump rotor 8, which is arranged on the first end portion of the rotation shaft 7, from being magnetized by the magnetic flux of the magnets 16. Accordingly, iron particles and the like are prevented from being attracted and adhered to the pump rotor 8 and entering gaps formed between the inner rotor 8b and the outer rotor 8a and between the outer rotor 8a and the inner surface of the pump chamber P. This allows for the pump rotor 8 to operate in a satisfactory manner. In addition, the pump housing 1 including the support bore 1a is made of a nonmagnetic metal. This inhibits magnetization of the pump housing 1. Accordingly, despite the use of a consequent pole rotor, the present embodiment prevents iron particles and the like from being attracted and adhered by magnetic force to the pump housing 1 including the support bore 1a. The electric pump can thus operate in a satisfactory manner without being interfered by iron particles and the like.

(2) The motor rotor core 15 includes a plurality of laminated core sheets. This structure prevents the generation of eddy current that may otherwise be generated in a consequent pole rotor, thereby improving the efficiency of the brushless motor and reducing the heat generated in the motor rotor core 15.

(3) The entire rotation shaft 7 is made of a nonmagnetic metal and serves as the magnetic resistance portion, thereby inhibiting magnetization of the first end portion of the rotation shaft 7 as well as of the pump rotor 8. This structure prevents iron particles and the like from being attracted and adhered to the first end portion of the rotation shaft 7 in the pump chamber P. Thus, operation of the electric pump is not affected by iron particles or the like.

(4) The circuit components are arranged on the side of the stator case 3 opposite to the pump housing 1. The second end portion of the rotation shaft 7, which is located near the circuit components, is a free end. If a shaft bearing were to support the second end of the rotation shaft 7, it would be necessary to inhibit magnetization of the shaft bearing.

This is not necessary in the present embodiment. For example, if the second end portion of the rotation shaft 7 is supported by a shaft bearing, a mechanism that inhibits magnetization of the shaft bearing is required to prevent the circuit components from being adversely affected by magnetic flux. The present embodiment eliminates the need for such a mechanism. Nevertheless, even if the second end portion of the rotation shaft 7 were to be supported by a shaft bearing, the present embodiment inhibits magnetization of the shaft bearing through the rotation shaft 7 because the rotation shaft 7 is made of a nonmagnetic metal. Accordingly, this minimizes the possibility of the circuit components from being adversely affected by magnetic flux.

(5) The motor rotor 9 is an interior permanent magnet rotor in which the magnets 16 are embedded in the pump housing 15. Thus, for example, even if the axis of the motor rotor 9 were to be out of alignment, the magnets 16 would not strike the motor stator 6. This prevents damaging of the magnets 16.

(6) The motor rotor 9 (motor rotor core 15) has an axial length that is less than the axial length of the pump rotor 8. This reduces the amount of the magnets 16 as compared to when the axial length of the motor rotor 9 is greater than or equal to the axial length of the pump rotor 8.

(7) The metal pump housing 1 and the metal stator case 3 are joined to each other by a spigot-and-socket joint. This ensures coaxial alignment of the pump housing 1 and the stator case 3, as well as the motor rotor 9 supported by the pump housing 1 and the motor stator 6 supported by the stator case 3 without the need for an performing machining to adjust inclinations, as may be required if, for example, the stator case is made of resin. The structure improves the pump performance and achieves quietness.

It should be apparent to those skilled in the art that the present invention may be embodied in many other specific forms without departing from the scope of the invention. Particularly, it should be understood that the invention may be embodied in the following forms.

In the above embodiment, the stator case 3 includes the large tube 3a, disk 3b, and fitting tube 3c. The fitting tube 1c of the pump housing 1 is fitted into the fitting tube 3c to form a spigot-and-socket joint. However, the stator case 3 may be modified to have a joint portion having any shape and structure as long as it forms a fitting joint with the pump housing 1.

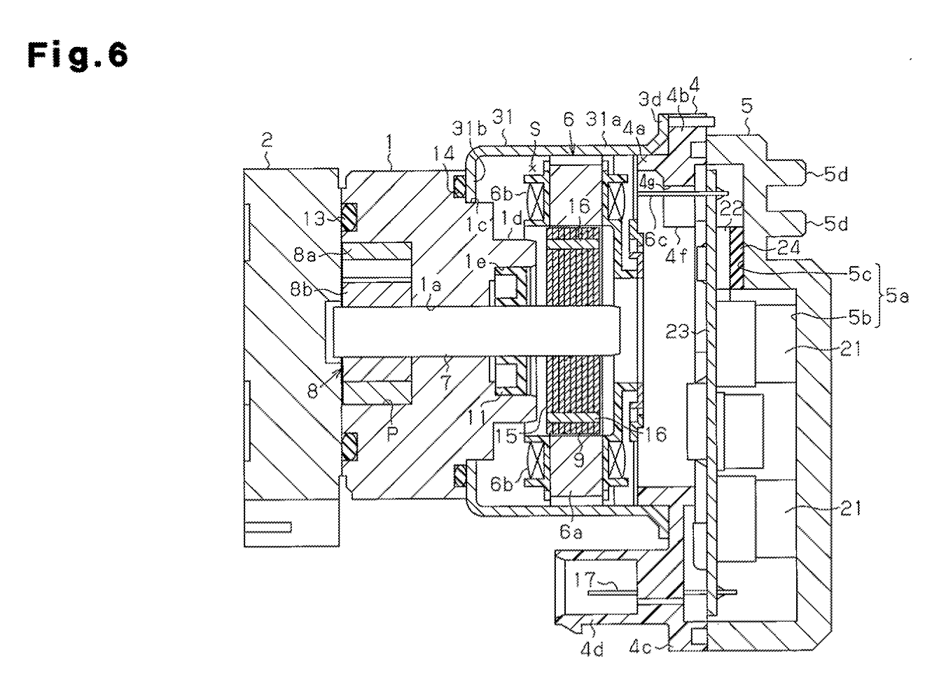

For example, the present embodiment may be modified as shown in FIG. 6. A stator case 31, formed from a metal plate, includes a large tube 31a and a disk 31b extending radially inward from a first end of the large tube 31a. The motor stator 6 is fixed to the inner circumference of the large tube 31a. The fitting tube 1c of the pump housing 1 is fitted in the disk 31b. The stator case 31 is formed from a metal plate and thus reduces manufacturing costs while providing higher rigidity compared to when the stator case 31 is made of resin, for example. In addition, the present embodiment allows for a simpler structure compared to the above embodiment including the fitting tube 3c. This further reduces the manufacturing costs of the stator case 31.

In the above embodiments, the pump housing 15 has a uniform thickness, or axial length. However, the pump housing 15 is not limited to such a structure, and the radially inner portion, in which the rotation shaft 7 is press-fitted, may have an axial length that is less than that of the radially outer portion.

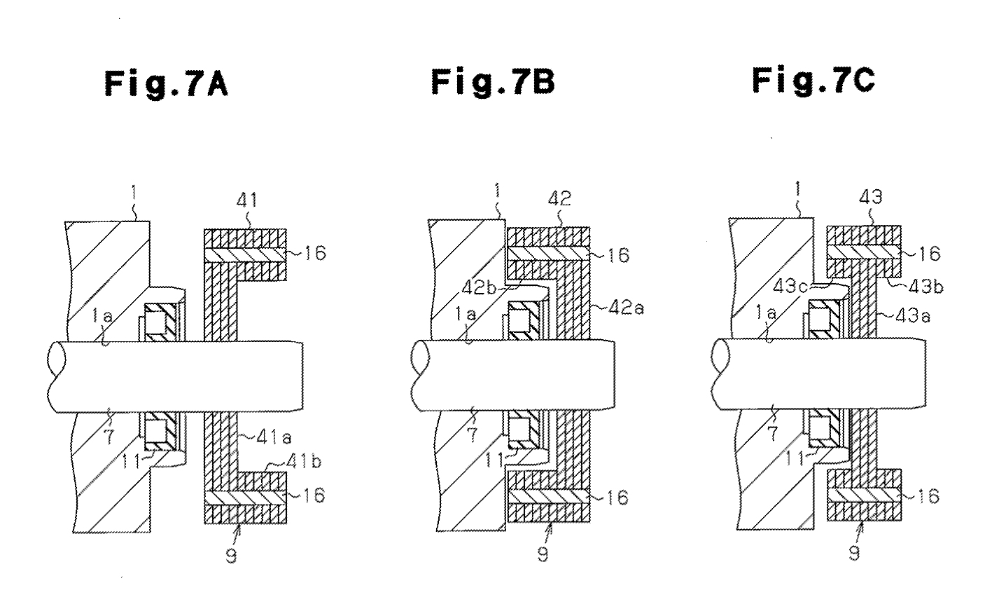

For example, the motor rotor core may be modified as shown in FIG. 7A. In this case, a motor rotor core 41 includes an annular cavity 41b at the side opposite to the pump housing 1 (right side as viewed in FIG. 7A), which is formed by reducing the axial length of a radially inner portion 41a.

Such a structure reduces the weight of the motor rotor core 41. Accordingly, the weight moment of the portion of the rotor unit that includes the motor rotor 9 may be reduced so as to advantageously balance the weight moments at the two axial sides of the rotor unit. The annular cavity 41b in the side opposite to the pump housing 1 further reduces the weight moment of the portion including the motor rotor 9 compared to when an annular cavity is arranged only in the side facing the pump housing 1. This facilitates the balancing of the weight moments at the two axial sides of the rotor unit.

FIG. 7B shows another embodiment of the present invention. A motor rotor core 42 of this embodiment includes an annular cavity 42b in the side facing the pump housing 1. The annular cavity 42b is formed by reducing the axial length of a radially inner portion 42a. At least part of the oil seal 11 is arranged in the annular cavity 42b. FIG. 7B shows the entire oil seal 11 arranged in the annular cavity 42b.

Such a structure reduces the weight of the motor rotor core 42. Accordingly, the weight moments at the two ends of the rotor unit can be easily balanced by reducing, for example, the weight moment of the portion including the motor rotor 9. In addition, the arrangement of at least part of the oil seal 11 in the annular cavity 42b allows for the overall axial length of the electric pump to be less than that of an electric pump that does not include the annular cavity 42b.

FIG. 7C shows a further embodiment. A motor rotor core 43 of this embodiment includes an annular cavity 43b in the side opposite to the pump housing 1 and an annular cavity 43c in the side facing the pump housing 1. The cavities 43b and 43c are formed by reducing the axial length of a radially inner portion 43a. At least part of the oil seal 11 is arranged in the annular cavity 43c. This embodiment has the same advantages as the embodiments described above.

In the above embodiment, the rotation shaft 7, which is made of a nonmagnetic metal, serves as the magnetic resistance portion. However, another magnetic resistance that can inhibit magnetization of the pump rotor 8 may be arranged between the magnets 16 and the pump rotor 8.

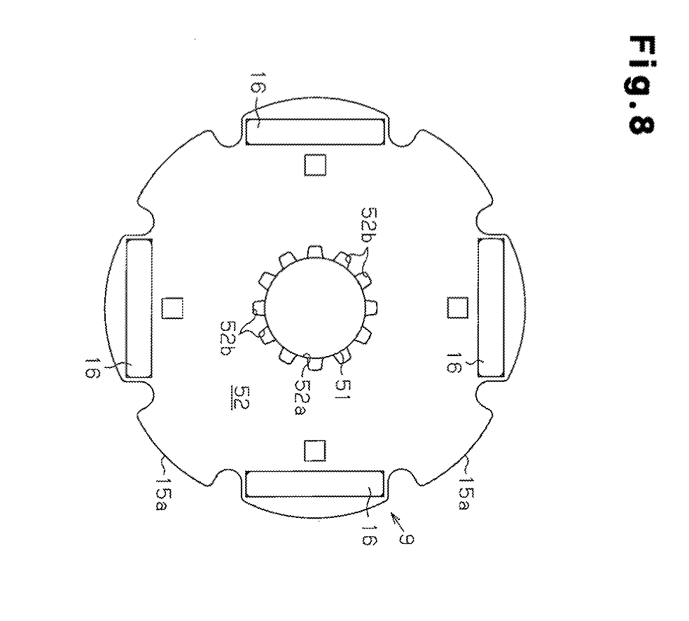

The embodiment shown in FIG. 8 includes a rotation shaft 51 that is not made of a nonmagnetic metal. Instead, this embodiment includes a motor rotor core 52 having a plurality of recesses 52b formed in the wall of a bore 52a, in which the rotation shaft 51 is press-fitted. The recesses 52b serve as a magnetic resistance portion that reduces the contact area between the motor rotor core 52 and the rotation shaft 51. This structure inhibits magnetization of the pump rotor 8 caused by the magnetic flux from the magnets 16.

In addition, a sleeve made of a nonmagnetic material may be arranged between the rotation shaft and the motor rotor core to serve as a magnetic resistance portion. Furthermore, in the rotation shaft, only the radially inner portion may be made of a nonmagnetic metal so as to serve as a magnetic resistance portion. In addition, a sleeve made of a nonmagnetic material may be arranged between the rotation shaft and the pump rotor to serve as a magnetic resistance portion.

In the above embodiment, the magnetic resistance portion arranged between the magnets 16 and the pump rotor 8 (rotation shaft 7 made of a nonmagnetic metal) serves as the magnetization inhibiting portion. However, the pump rotor may be made of a nonmagnetic material so as to serve as the magnetization inhibiting portion. This structure inhibits the pump rotor from being magnetized by any magnetic flux or magnetic field.

In the above embodiment, the entire pump housing is made of a nonmagnetic metal. However, as long as at least the portion forming the support bore 1a, or support portion, is made of a nonmagnetic material, the pump housing may be made of a material other than a nonmagnetic metal. Instead, a sleeve made of a nonmagnetic metal may be arranged between the pump housing and the rotation shaft to serve as a support portion.

In the above embodiment, the fitting joint of the pump housing 1 and the stator case 3 has a diameter (i.e., the outer diameter of the fitting tube 1c and the inner diameter of the fitting tube 3c) that is greater than the inner diameter of the motor stator 6. However, the present invention is not limited to such as structure, and the diameters may be the same.

In the above embodiment, the pump housing 1 and the stator case 3 are fixed to each other by the bolts 12 extending over the entire axial length of the electric pump. However, the present invention is not limited to such a structure, and other structure may be used for fixation.

In the above embodiment, the circuit case 4 is sandwiched between the stator case 3 and the heat sink cover 5. However, the present invention is not limited to such a structure, and other structure may be used.

In the above embodiment, the accommodating portion 5a includes the large cavity 5b and the small cavity 5c. However, the present invention is not limited to such a structure, and the accommodating portion 5a may include only one cavity with a uniform depth, for example.

In the above embodiment, the fin 5d is arranged on the outer end face of the heat sink cover 5 in a portion corresponding to the small cavity 5c. However, the present invention is not limited to such a structure. For example, the fin 5d may be omitted, or a fin may be arranged on the outer end face in a portion corresponding to the large cavity 5b.

In the above embodiment, the small cavity 5c accommodates the power transistor 22. However, the present invention is not limited to such a structure, and the small cavity 5c does not have to accommodate the power transistor 22. In addition, the silicone rubber member 24 between the power transistor 22 and the bottom of the small cavity 5c may be omitted, and the power transistor 22 may be spaced apart from the bottom of the small cavity 5c.

In the above embodiment, the circuit case 4 includes the holding groove 4g, and the stator case 3 and the circuit case 4 include holding portions (the tabs 3e and the slot 4e) that prevent relative movement of the stator case 3 and the circuit case 4. However, the present invention is not limited to such a structure, and the holding groove 4g and the holding portions (tabs 3e and slots 4e) may be omitted. In addition, the holding groove 4g (holding portion) may be modified as long as it holds and guides the coil connecting terminal 6c toward the accommodating portion 5a. For example, the holding groove 4g may be replaced by a holding bore that extends in the axial direction.

In the above embodiment, the pump housing 15 includes laminated core sheets. However, the present invention is not limited to such a structure, and the motor rotor core may be made of a sintered metal.

In the above embodiment, the motor rotor 9 is an interior permanent magnet rotor in which the magnets 16 are embedded in the pump housing 15. However, the present invention is not limited to such a structure, and the motor rotor 9 may be replaced by a surface permanent magnet rotor in which magnets are arranged on the outer surface of a rotor core.

In the above embodiment, the rotor unit including the rotation shaft 7, pump rotor 8, and motor rotor 9 is formed such that the weight moment of the portion from the axial center to the pump rotor 8 conforms to the weight moment of the portion from the axial center of the pump rotor 8 to the motor rotor 9. However, the present invention is not limited to such a structure, and other structures may be used.

In the above embodiment, the axial center of the motor stator 6 is offset in the axial direction from the axial center of the motor rotor 9. However, the present invention is not limited to such a structure, and the axial centers of the motor stator 6 and the motor rotor 9 may be aligned in the axial direction.

In the above embodiment, the axial center of the motor stator 6 is offset from the axial center of the motor rotor 9 in the axial direction away from the pump chamber P. However, the present invention is not limited to such a structure, and the axial center of the motor stator 6 may be offset in the axial direction toward the pump chamber P.

In the above embodiment, the motor rotor 9 is a flat rotor having a diameter that is greater than its axial length. However, the present invention is not limited to such a structure, and a rotor having a diameter that is less than its axial length. In addition, in the above embodiment, the motor rotor 9 (pump housing 15) has an axial length that is less than the axial length of the pump rotor 8. However, the present invention is not limited to such a structure, and the motor rotor 9 may have an axial length that is greater than or equal to the axial length of the pump rotor 8.

In the above embodiment, the pump rotor 8 is of an internal gear type. However, the pump rotor 8 may be replaced by another pump rotor that is capable of performing fluid suction and discharge.

In the above embodiment, the present invention is embodied in an electric pump that circulates oil in a vehicle. However, the present invention may be embodied in other driving devices, such as an electric pump used for other applications and an electric fan for supplying gas.

Therefore, the present examples and embodiments are to be considered as illustrative and not restrictive and the invention is not to be limited to the details given herein, but may be modified within the scope and equivalence of the appended claims.

1. A driving device comprising:
a rotor unit including a rotation shaft, a fluid supplying portion, and a motor rotor, wherein
the rotation shaft includes a first end portion, a second end portion, and a middle portion,
the fluid supplying portion is arranged at the first end portion of the rotation shaft, and
the motor rotor is arranged at the second end portion of the rotation shaft;
a housing including a first end portion, a second end portion, and a support portion, which rotatably supports the middle portion of the rotation shaft, wherein the first end portion includes a supplying chamber that accommodates the fluid supplying portion; and
a stator case arranged adjacent to the second end portion of the housing, wherein the stator case accommodates a motor stator and a motor rotor arranged in the motor stator, and the motor stator fixed to the stator housing, wherein
the motor rotor forms a consequent pole rotor including a motor rotor core and a plurality of magnets arranged along a circumferential direction of the motor rotor core,
the magnets form a plurality of magnetic pole portions each serving as a primary magnetic pole,
the motor rotor core includes a portion located between adjacent ones of the magnetic pole portions in the circumferential direction that defines a magnetic-pole-forming portion serving as a secondary magnetic pole,
the motor unit includes a magnetization inhibiting portion formed to inhibit magnetization of the fluid supplying portion, and
the support portion of the housing includes a nonmagnetic metal.

2. The driving device according to claim 1, wherein the motor rotor core includes a plurality of laminated core sheets.

3. The driving device according to claim 1, wherein the magnetization inhibiting portion includes a magnetic resistance portion arranged between the magnets and the fluid supplying portion.

4. The driving device according to claim 3, wherein the magnetic resistance portion is arranged at least in the proximity of the second end portion of the rotation shaft.

5. The driving device according to claim 1, wherein
the housing includes a nonmagnetic metal, and
the magnetization inhibiting portion includes the rotation shaft that includes a nonmagnetic metal.

6. The driving device according to claim 1, further comprising a circuit component arranged at a side of the stator case opposite to the housing, wherein the second end portion of the rotation shaft is a free end.

7. The driving device according to claim 1, wherein the magnetization inhibiting portion includes the fluid supplying portion that includes a nonmagnetic material.

8. The driving device according to claim 1, wherein the magnets are embedded in the motor rotor core.

9. The driving device according to claim 1, wherein
the fluid supplying portion is of an internal gear type and includes an inner rotor, which is fixed to the rotation shaft and includes an external tooth, and an outer rotor, which includes a groove that engages with the external tooth,
rotation of the inner rotor rotates and moves the outer rotor along an inner wall of the supplying chamber, and
the motor rotor core has an axial length that is less than that of the fluid supplying portion.

10. The driving device according to claim 1, wherein
the motor rotor core includes a radially inner portion, in which the rotation shaft is press-fitted, and a radially outer portion, and
the radially inner portion has an axial length that is less than that of the radially outer portion.

11. The driving device according to claim 10, further comprising an oil seal held by the housing and fitted on the rotation shaft, wherein
the oil seal is arranged between the supplying chamber and an accommodating chamber accommodating the motor stator,
the radially inner portion of the motor rotor core includes an annular cavity at a side facing the housing, and
at least part of the oil seal is arranged in the annular cavity.

12. The driving device according to claim 1, wherein
the housing includes metal,
the stator case includes metal, and
the stator case and the housing are joined to each other with a fitting joint.
